(19) United States
(12) Patent Application Publication
(10) Pub. No.: US 2023/0071300 A1
(43) Pub. Date: Mar. 9, 2023

(54) SYSTEMS AND METHODS FOR PRIVACY-SAFE USER TRACKING

(71) Applicant: Xandr Inc., New York, NY (US)

(72) Inventors: Matthew Haies, New York, NY (US); Michiel Nolet, New York, NY (US); Adam Turkel, New York, NY (US)

(21) Appl. No.: 17/987,740

(22) Filed: Nov. 15, 2022

Related U.S. Application Data
(63) Continuation of application No. 14/181,237, filed on Feb. 14, 2014, now abandoned.
(60) Provisional application No. 61/765,223, filed on Feb. 15, 2013.

(51) Int. Cl. G06Q 30/02

(52) U.S. Cl. CPC G06Q 30/0255

(57) ABSTRACT

Computer-implemented systems and methods for privacy-safe user tracking. A plurality of tracking pools is provided, with each tracking pool having a plurality of users assigned to the pool. Each tracking pool further includes combined tracking data associated with the users in the pool. Tracking data associated with a user is received, and the user is assigned to at least one of the tracking pools. The received tracking data is added to the combined tracking data of the assigned tracking pool, such that no portion of the combined tracking data can be used to identify an individual user in the assigned tracking pool.

### CROSS-REFERENCE TO RELATED APPLICATION

This application claims priority to and the benefit of U.S. provisional patent application No. 61/765,223, entitled “System and Method for Privacy-Safe User Tracking,” filed on Feb. 15, 2013, and which is incorporated in its entirety herein.

### BACKGROUND

The present disclosure relates generally to systems and methods for tracking users while protecting the privacy of individual users and, more particularly, to systems and methods for creating and maintaining user tracking pools in which user data is combined and stored in a manner such that no portion of the information can be used to identify any individual user in the pool.

Online advertising companies use various methods to track the activities of website users, with the goal of providing targeted advertisements to those users. Browser cookies are one means of tracking website visitors, and often include a small segment of data, representing the user's previous activity, which is stored on the user's computer for later retrieval by a website. By tracking whether a particular user has visited a website, clicked a link, viewed an advertisement, or taken some other action, an advertiser can tailor future advertisements to the user.

For some users, however, cookies are blocked, regularly deleted, or otherwise unsupported, leading to an inability to accurately track the past activities of these users. Some methods of tracking attempt to overcome this deficiency. One method, known as “fingerprinting,” attempts to identify users by gathering a potentially unique combination of characteristics associated with each user. For example, a website can log operating system configurations, browser headers, plug-in information, IP address, and other information that can be accessible by or provided to the website through the user's browser or other means. By comparing the captured characteristics with previously stored combinations, a website can recognize the user with reasonable accuracy and store tracking information associated with the user on the server side.

These and other existing user tracking methods raise issues relating to the privacy and anonymity of web users, especially when users can be identified with particularity and associated with their behaviors, browsing history, age, location, and other sensitive information. As a result, some countries have passed legislation addressing user tracking on the web, and further restrictions are likely as the technology continues to evolve. However, the ability to have some means of identifying users and providing relevant advertisements is crucial to the success of advertisers and, ultimately, to the proliferation of freely available content on the web. Accordingly, there is a need for methods and systems for tracking the activities of web users while preserving their privacy.

### BRIEF SUMMARY

Systems and methods are presented for privacy-safe user tracking by creating and maintaining pools of combined user tracking data. Identified users are assigned to tracking pools, in which the characteristics and/or activities of each individual user in a pool are combined with the characteristics and/or activities of other users in the pool. By combining the tracking data of the users in the pool, users are not individually identifiable given knowledge of any particular portion of tracking data. In essence, the user becomes another “face in the crowd.” Various actions can be taken based on the combined data for a pool; for example, an advertisement can be served to a user assigned to the pool, or conversion attribution can be performed.

In one aspect, a computer-implemented method includes the steps of: providing a plurality of tracking pools, each tracking pool having a plurality of users assigned to the pool, each tracking pool including combined tracking data associated with the users in the pool; receiving tracking data associated with a user; assigning the user to at least one of the tracking pools; and adding the received tracking data to the combined tracking data of the assigned tracking pool, such that no portion of the combined tracking data can be used to identify an individual user in the assigned tracking pool.

In one implementation, the method further includes: receiving a request for an advertisement to be served to a second user; identifying at least one of the tracking pools associated with the second user; and facilitating a determination of whether to serve a particular advertisement to the second user based on the combined tracking data associated with the identified tracking pool. The determination can be based at least in part on a combined advertisement viewing history of the users in the identified tracking pool. The determination can also be based at least in part on a combined website visit history of the users in the identified tracking pool.

Further implementations of the method include one or more of the following features. The tracking data can include at least one of demographic information, geographic information, social networking information, browser history, advertisement view history, advertisement click history, and conversion history. The combined tracking data of at least one of the tracking pools can include an aggregation of tracking data associated with the users in that pool. The combined tracking data of at least one of the tracking pools can include a statistical representation of tracking data associated with the users in that pool. The user can be assigned to the at least one of the tracking pools based on at least one of the received tracking data and the combined tracking data of the assigned tracking pool. The user can be randomly assigned to the at least one of the tracking pools.

In another implementation, the method further includes receiving a unique tracking identifier associated with the user. The tracking identifier can include browser cookie data and/or a browser fingerprint. Assigning the user to at least one of the tracking pools can include mapping the tracking identifier to a unique pool identifier associated with the assigned tracking pool. The number of users assigned to each tracking pool can be greater than or equal to a minimum privacy threshold, and/or less than or equal to a maximum tracking threshold. Each user assigned to a tracking pool can share at least one portion of tracking data with the other users assigned thereto.

In yet another implementation, the method further includes performing conversion attribution based on the combined tracking data in at least one of the tracking pools.

In another aspect, a system includes one or more computers programmed to perform operations including: providing a plurality of tracking pools, each tracking pool having a plurality of users assigned to the pool, each tracking pool including combined tracking data associated with the users in the pool; receiving tracking data associated with a user; assigning the user to at least one of the tracking pools; and adding the received tracking data to the combined tracking data of the assigned tracking pool, such that no portion of the combined tracking data can be used to identify an individual user in the assigned tracking pool.

In one implementation, the operations further include: receiving a request for an advertisement to be served to a second user; identifying at least one of the tracking pools associated with the second user; and facilitating a determination of whether to serve a particular advertisement to the second user based on the combined tracking data associated with the identified tracking pool. The determination can be based at least in part on a combined advertisement viewing history of the users in the identified tracking pool. The determination can also be based at least in part on a combined website visit history of the users in the identified tracking pool.

Further implementations of the system include one or more of the following features. The tracking data can include at least one of demographic information, geographic information, social networking information, browser history, advertisement view history, advertisement click history, and conversion history. The combined tracking data of at least one of the tracking pools can include an aggregation of tracking data associated with the users in that pool. The combined tracking data of at least one of the tracking pools can include a statistical representation of tracking data associated with the users in that pool. The user can be assigned to the at least one of the tracking pools based on at least one of the received tracking data and the combined tracking data of the assigned tracking pool. The user can be randomly assigned to the at least one of the tracking pools.

In another implementation, the operations further include receiving a unique tracking identifier associated with the user. The tracking identifier can include browser cookie data and/or a browser fingerprint. Assigning the user to at least one of the tracking pools can include mapping the tracking identifier to a unique pool identifier associated with the assigned tracking pool. The number of users assigned to each tracking pool can be greater than or equal to a minimum privacy threshold, and/or less than or equal to a maximum tracking threshold. Each user assigned to a tracking pool can share at least one portion of tracking data with the other users assigned thereto.

In yet another implementation, the operations further include performing conversion attribution based on the combined tracking data in at least one of the tracking pools.

The details of one or more implementations of the subject matter described in the present specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 is a diagram illustrating an example assignment of user tracking identifiers to tracking pools.

FIG. 2 is a flowchart illustrating an example method for privacy-safe user tracking.

FIG. 3 is a flowchart illustrating an example method for privacy-safe advertisement serving.

FIG. 4 is a diagram illustrating example combined user tracking data.

FIG. 5 is a diagram illustrating an example system architecture.

### DETAILED DESCRIPTION

Described herein in various implementations are systems and accompanying methods for privacy-safe user tracking in the context of, for example, online advertising. To protect web-user privacy while satisfying the goals of targeted advertising, it is necessary to provide sufficient separation between users and tracking information that could be used to identify the users. The implementations described in the present disclosure provide a layer of abstraction between users and tracking data by pooling groups of users that can have similar characteristics and combining the tracking data associated with the users. The combined data can be made available to an advertising platform to be used in determining, for example, whether to serve a particular advertisement to a user or how to attribute conversions.

As used herein, the term “user” can refer to any person, entity, or software that performs a trackable action, such as browsing a website, viewing an advertisement, using a software application, and the like, and/or has a trackable characteristic, such as age, location, operating system used, browser used, version number, and the like. Thus, it is to be appreciated that, although the implementations described herein refer primarily to tracking and protecting the privacy of website users, the present implementations are applicable to any system or technique that can benefit from the advantages provided herein. For example, the described privacy-safe tracking and information pooling techniques can be implemented with respect to users of websites, mobile applications, desktop applications, software-as-a-service, and other systems on which user tracking information can be collected.

Website users can be uniquely identified to a reasonable degree using a variety of techniques. For example, such users can be identified through identification methods including browser cookies, fingerprinting, hashed device IDs (e.g., for Android-based devices), advertising identifiers (e.g., for iOS-based devices), and/or any other identification method, including those available on mobile platforms. Upon associating a user with a unique tracking identifier, various tracking information related to the user can be tracked over time and associated with the unique identifier for later retrieval and analysis.

“Tracking data” or “tracking information” can refer to trackable actions, behaviors, and/or characteristics associated with one or more users. Various types of information can be tracked for individual users and/or groups of users, such as demographics (e.g., age, income range, education level), geography (e.g., city, state, region, country), social networking information (e.g., user name, connections, friends, likes), browsing habits, browsing history, conversion history (e.g., purchases, sign-ups), advertisement view history, advertisement click history, advertisement recency history (i.e., how recently a particular advertisement was served), advertisement frequency history (i.e., the number of times a particular advertisement has been served within a time period), and any other trackable action, behavior, characteristic, context, or information.

To create a layer of anonymity between users and their tracked information, users can be assigned to one or more “tracking pools.” As used herein, a “tracking pool” refers to a grouping of users in which tracking data associated with the users is combined such that no portion of the combined data can be used to identify an individual user in the pool. Users in a pool can share in common one or more portions or types of tracking data (e.g., all users have visited google.com at least once in the past 24 hours, all users are in the age range of 25-30, all users have at least a 5% click rate for targeted advertisements). In other implementations, a fraction of the users share in common one or more portions or types of tracking data (e.g., 80% of the users in the pool have visited google.com at least once in the past 24 hours). In further implementations, very few or none of the users share in common one or more portions or types of tracking data.

One way to perform the assignment of a user to a tracking pool is to map the unique identifier of the user (e.g., cookie ID, fingerprint, etc.) to a unique pool identifier. A user can be assigned to a pool based on certain tracked actions, behaviors and/or characteristics of the user, and/or based on tracked actions, behaviors and/or characteristics shared by users already assigned to pools. In some implementations, users are assigned to pools randomly, in round-robin fashion, or by using various other suitable techniques. As a result, pools can be formed such that users within a pool share some or no common tracking information.

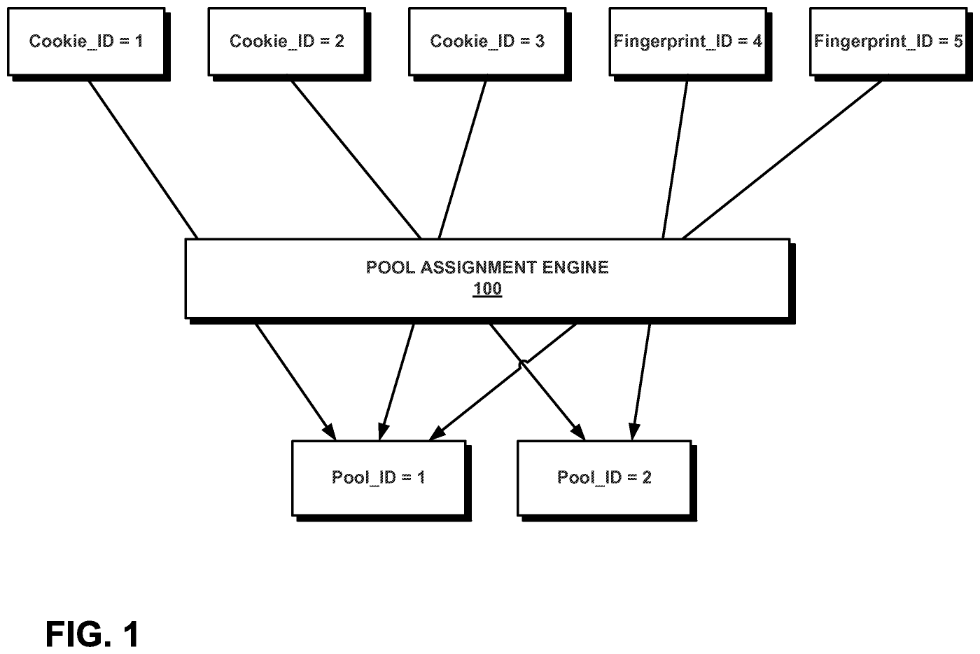

As shown in FIG. 1, a Pool Assignment Engine 100 maps user tracking identifiers to unique pool identifiers. Cookie-based identifiers, Cookie_ID=1 and Cookie_ID=3, and fingerprint-based identifier, Fingerprint_ID=5, are assigned by the Pool Assignment Engine 100 to one pool, Pool_ID=1; and Cookie_ID=2 and Fingerprint_ID=4 are assigned by the Pool Assignment Engine 100 to a second pool, Pool_ID=2. Although the pool assignments are depicted as mutually exclusive, in some implementations the user identifiers can be mapped to multiple pools. The Pool Assignment Engine 100 can also track the assigned user identifiers and pool size (i.e., the number of users assigned to a pool) in a continuous or periodic manner (e.g., hourly, daily, weekly, monthly) to ensure that stale or changing fingerprints , client-side cookie data, or other user identifiers are removed from pools.

In one implementation, instead of separately storing the tracking information of each individual user, the information associated with the users in a pool (e.g., the types of tracking information described above) is maintained in a combined form such that no portion of the information can be used to identify an individual user in the pool. The user data can be “combined” by various methods, such as aggregation, unioning, statistical sampling, and/or other methods. In some implementations, no information is lost in combining the tracking information of each user in a pool. In other implementations, the information is fully or partially condensed by eliminating redundancies, abstracting the data and/or replacing subsets of data with statistical representations. The combined information for each pool can be mapped to the unique pool identifier. Further, in some implementations, no information directly identifying a user, such as IP addresses, names, credit card numbers, and the like, is stored with the pooled tracking information. Further, combined tracking data can be made accessible only via the pool identifiers and not through providing user tracking identifiers alone (i.e., a user identifier must be mapped to a pool identifier to retrieve combined data, thus further protecting user privacy).

Consider, for example, a pool with ten users, eight of which have visited the website, Toyota.com. Based on the combined tracking data in the pool, it is known that there have been eight total visits of Toyota.com, but it is not possible to determine which individual users are the actual visitors. It is, however, possible to derive the probability of any given user in the pool having visited the website. Accordingly, if an action is to be taken with respect to a user in the pool (e.g., whether to show the user a car-related advertisement), it can be determined that there is an 80% (8 out of 10) chance that the user has visited Toyota.com. The result of this technique is that a particular user in the pool cannot be identified with 100% certainty based on knowledge that the user visited or did not visit Toyota.com.

It is to be appreciated that the level of anonymity will vary based on the size of the pool and the number of characteristics or other pieces of information tracked in combination for the pool. To ensure a pool provides adequate anonymity to each of its assigned users, a minimum number of users can be required to be assigned to the pool before the pool can be utilized by advertisers (i.e., a minimum privacy threshold). For example, a minimum privacy threshold of 10 users can be necessary to provide sufficient anonymity to the users in a pool. However, if the number of users in a pool is too large, the combined data may be of reduced utility.

Expanding on the above example, if there are 100 users in the pool instead of ten, but the number of Toyota.com visitors is unchanged (eight visitors), then the likelihood that an identified user assigned to the pool has visited Toyota.com is likely too small (8%, or 8 out of 100) to be useful to an advertiser desiring to target Toyota.com visitors. Thus, a maximum number of users (i.e., a maximum tracking threshold) can impose a limit on the number of users that can be assigned to a particular pool. In some implementations, different pools can utilize different minimum and maximum thresholds, which can depend on the various characteristics and behaviors tracked by the pools. Other methods of pooling users can be utilized such that specific users within a pool can be tracked at a more detailed level while still maintaining relative anonymity, as described above.

In some implementations, each user in a pool shares one or more common characteristics, behaviors, and/or other trackable information. For example, a first pool of users can all be within the age range of 25-29 and reside in the Northeast U.S. A second pool of users can be characterized by the frequency with which they visit a website (e.g., all the users in assigned to the group visit eBay.com at least three times a week). A third pool of users can be known to have a high frequency of purchasing an item after clicking an advertisement. In some circumstances, grouping users by common characteristics ultimately makes the pooled data more useful to advertisers, as they can target advertisements to a particular user characteristic or behavior with a higher certainty.

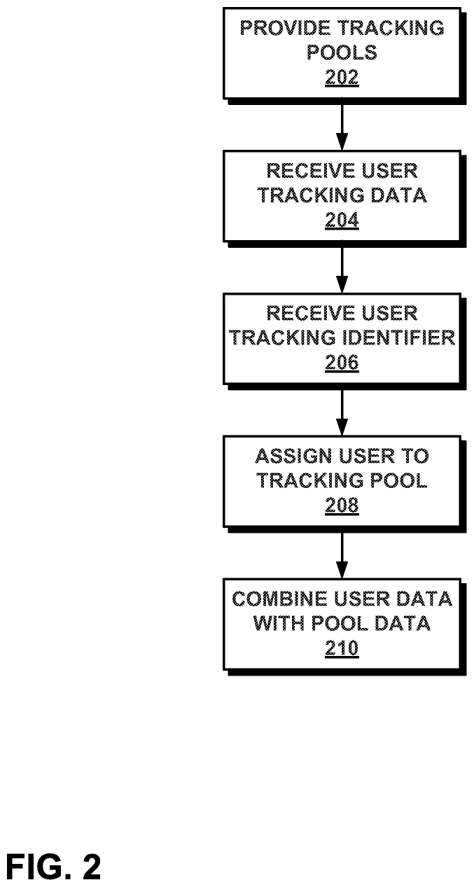

Referring now to FIG. 2, a method for privacy-safe user tracking includes providing one or more tracking pools, as described herein (STEP 202). Each tracking pool can have multiple users assigned to the pool, and combined tracking data associated with the users in the pool can be maintained for each individual pool. In STEPS 204 and 206, tracking data and a unique tracking identifier associated with a user is received. The user is then assigned to a tracking pool (STEP 208). The assignment can be based on the received tracking data associated with the user and/or the tracking data associated with the pool(s) to which the user is assigned. The received user data is then added to the combined tracking data associated with the assigned tracking pool(s), such that no portion of the combined tracking data can be used to identify an individual user in the assigned tracking pool(s).

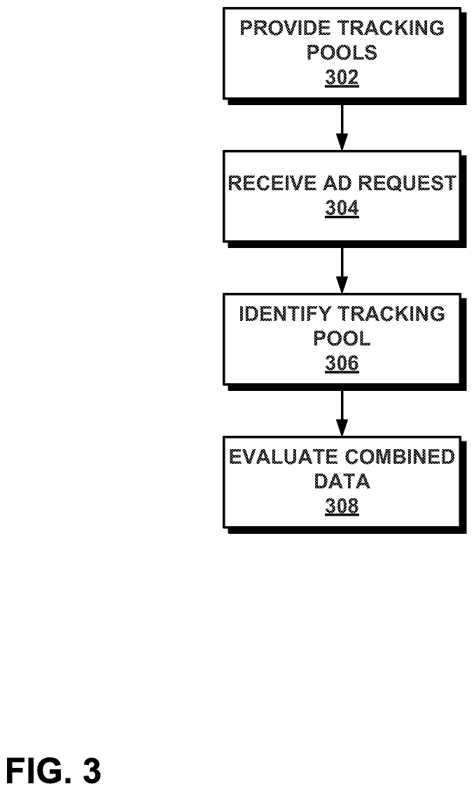

The combined tracking information maintained for user tracking pools can be used in advertising applications or for other various purposes. As shown in FIG. 3, in one implementation, an advertiser uses the combined tracking information to determine whether to serve a targeted advertisement to a particular user. In STEP 302, one or more tracking pools are provided, as described herein. Upon a request for an advertisement to be served to a user identified by a unique tracking identifier (STEP 304), a lookup is performed for the pool identifier mapped to the user tracking identifier and the pool size associated with the pool (STEP 306). The combined tracking data mapped to the pool identifier can then be made available to one or more advertisers for evaluation and analysis, thereby facilitating the determination of whether to serve a particular advertisement to the user based on the combined tracking data associated with the identified tracking pool (STEP 308).

Each advertiser can use its own algorithms and thresholds to determine whether to serve advertisements based on pool data. For example, if one user in a pool is known to have visited eBay.com, then all the users assigned to the pool can be considered eligible to have targeted advertising relevant to eBay.com served to them. In other circumstances, an advertiser can require at least 25%, 50%, 75% (or other appropriate percentage) of the users in a pool to have visited eBay.com in order to serve targeted advertisements to any of them. In some implementations, if the users in the pool share several common characteristics (e.g., same age group and same geographic region), then a lower percentage of users visiting eBay.com can be necessary to open up targeting advertising to all in the group. The more users in a tracking pool that have common characteristics, the more likely are targeted advertisements to be relevant to each user assigned to the pool.

In one implementation, the combined tracking data for a pool can be used for probabilistic advertisement frequency capping. For example, if the pool contains ten members, and the members assigned to the pool have, in aggregate, seen two ads in the last 24 hours, it can be assumed that, on the next request to serve an advertisement to a pool member, that the member has seen 0.2 ads in the past 24 hours. In another implementation, a deterministic assessment of the pool data is made; i.e., it is assumed that any given user in the pool represents the entirety of the pool and, thus, for the next ad call for a pool member, it is assumed the member has already seen two ads.

In another implementation, conversion attribution can be performed based on the combined tracking data associated with the tracking pools. A conversion can be attributed by matching a conversion event (e.g., a purchase or sign-up based on an advertisement) having a unique pool identifier to any prior impression, view, or interaction with a relevant advertising impression. Conversions can be discounted appropriately by the probability of the given pool member having seen the ad based on the history of the entire pool. For example, a pool with ten members for which 100 ad impressions were shown for a specific advertiser has a high probability of all users having seen the advertisement.

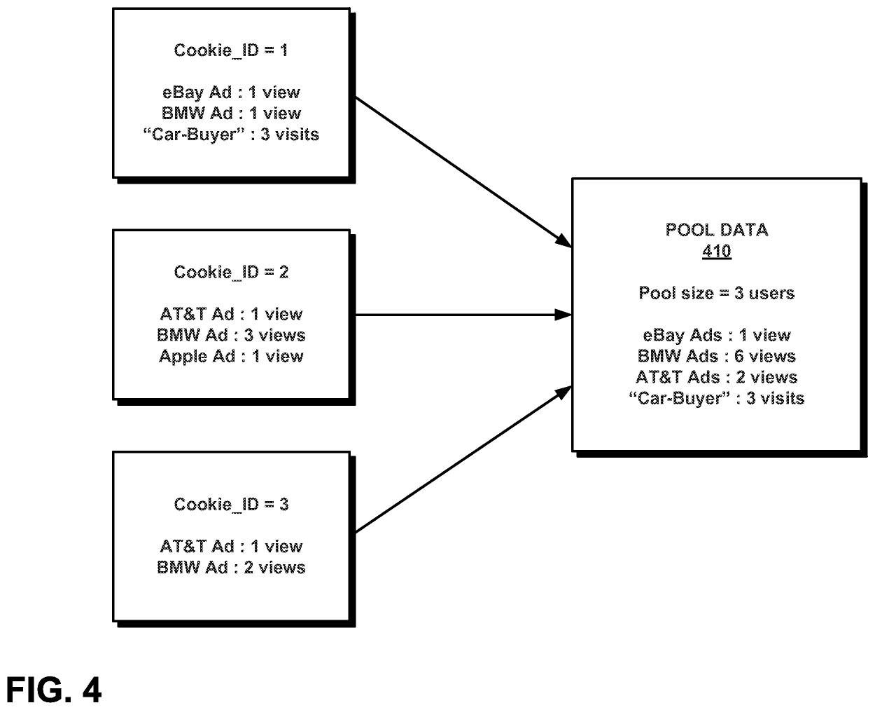

One implementation of a pooling technique is illustrated in FIG. 4. As depicted, user tracking identifiers (Cookie_ID=1; Cookie_ID=2; and Cookie_ID=3) are assigned to a single pool, which has associated combined tracking data 410. The user associated with Cookie_ID=1 has viewed an eBay ad and a BMW ad once, and has visited websites associated with a “car-buyer” group (e.g., Toyota.com, Ford.com, AutoTrader.com, etc.) three times. The user associated with Cookie_ID=2 has viewed an AT&T ad and an Apple ad once, and has viewed BMW ads three times. The user associated with Cookie_ID=3 has viewed an AT&T ad once, and has viewed BMW ads twice. The pool does not map the view and visit data to each user, but instead maintains the data in a combined form 410. Thus, to an advertiser utilizing the pool data, three users have, in total, viewed eBay ads once, viewed BMW ads six times, viewed AT&T ads twice, and visited “car-buyer” websites three times.

Advertisers and other parties can utilize combined tracking data in a pool in various manners, such as those described in the following examples, with reference to the data depicted in FIG. 4.

Example #1: AT&T desires to determine whether to serve an advertisement having a frequency cap of three impressions per 24 hours. In considering the pool data 410, AT&T observes that the pool has two views of AT&T ads within the last 24 hours, or less than the frequency cap of three. Accordingly, AT&T decides to show the third view to the pool.

Example #2: BMW desires to serve behaviorally targeted ads to “car buyers.” BMW can require a threshold minimum number of visits to “car-buyer” websites in order to make the pool eligible for targeted ads. For example, BMW can require at least two visits to “car-buyer” websites for a pool of at least three users (e.g., a minimum threshold of two-thirds). Because the pool data 410 has a count of “3” for “car-buyer” visits, an impression served to any of the users in the pool will be eligible for the BMW campaign, even though only one of the users actually visited a “car-buyer” website.

Example #3: Conversion attribution after a user in the pool purchases an item on eBay. Because the combined pool tracking data 410 includes one view of an eBay advertisement and the size of the pool is three users, the probability that any given user in the pool viewed the ad is approximately 0.333. As such, for the purposes of conversion attribution, the likelihood that the user viewed the eBay ad prior to making the purchase is 0.333. The attribution is therefore reduced accordingly, such that the attributed “post-view” conversion for the purchase is one-third of the full amount that would otherwise be attributed if the purchasing user were directly linkable to the eBay ad view. However, other attribution models can be used such that a one-third view probability does not directly translate to a one-third conversion attribution.

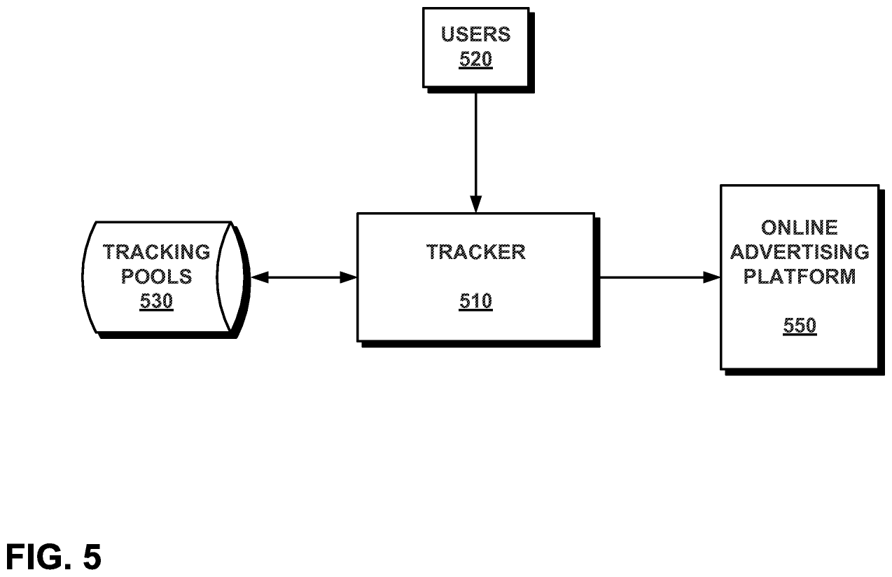

A system for performing the techniques described herein can include one or more computing devices programmed to execute one or more software modules and/or perform one or more operations. Referring to FIG. 5, in one implementation, an tracker 510 receives user data and unique user tracking identifiers from users 520 via user devices (e.g., laptops, mobile phones, tablets, etc.). The tracker 510 assigns the users 520 to one or more stored user tracking pools 530. The tracker 510 maintains, for each pool 530, combined tracking information associated with the users 520 assigned to the pools 530, such that no portion of the information can be used to identify any one user in the pool. The system can further include an online advertising platform 550 or advertising server for facilitating the serving of advertisements to users 520 in the tracking pools 530 based on the combined information maintained in association with the pools 530.

Implementations of the system can use appropriate hardware or software; for example, it can execute on a system capable of running an operating system such as the Microsoft Windows® operating systems, the Apple OS X® operating systems, the Apple iOS® platform, the Google Android™ platform, the Linux® operating system and other variants of UNIX® operating systems, and the like.

Some or all of the described functionality can be implemented in software and/or hardware a user's device. A user device can include, but is not limited to, a smart phone, smart watch, smart glasses, tablet computer, portable computer, television, gaming device, music player, mobile telephone, laptop, palmtop, smart or dumb terminal, network computer, personal digital assistant, wireless device, information appliance, workstation, minicomputer, mainframe computer, or other computing device, that is operated as a general purpose computer or a special purpose hardware device that can execute the functionality described herein. The software, for example, can be implemented on a general purpose computing device in the form of a computer including a processing unit, a system memory, and a system bus that couples various system components including the system memory to the processing unit.

Additionally or alternatively, some or all of the functionality can be performed remotely, in the cloud, or via software-as-a-service. For example, matching functions can be performed on one or more remote servers or other devices, as described above, that communicate with the user devices. The remote functionality can execute on server class computers that have sufficient memory, data storage, and processing power and that run a server class operating system (e.g., Oracle® Solaris®, GNU/Linux®, and the Microsoft® Windows® family of operating systems).

The systems can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

Method steps of the techniques described herein can be performed by one or more programmable processors executing one or more computer programs to perform functions by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

In various implementations, a user device includes a web browser, native application, or both, that facilitates execution of the functionality described herein. A web browser allows the device to request a web page or other downloadable program, applet, or document (e.g., from the server(s)) with a web page request. One example of a web page is a data file that includes computer executable or interpretable information, graphics, sound, text, and/or video, that can be displayed, executed, played, processed, streamed, and/or stored and that can contain links, or pointers, to other web pages. In one implementation, a user of the device manually requests a web page from the server. Alternatively, the device automatically makes requests with the web browser. Examples of commercially available web browser software include Microsoft® Internet Explorer®, Mozilla®, Firefox®, and Apple® Safari®.

In some implementations, the user devices include client software. The client software provides functionality to the device that provides for the implementation and execution of the features described herein. The client software can be implemented in various forms, for example, it can be in the form of a native application, web page, widget, and/or Java, JavaScript, .Net, Silverlight, Flash, and/or other applet or plug-in that is downloaded to the device and runs in conjunction with the web browser. The client software and the web browser can be part of a single client-server interface; for example, the client software can be implemented as a plug-in to the web browser or to another framework or operating system. Other suitable client software architecture, including but not limited to widget frameworks and applet technology can also be employed with the client software.

A communications network can connect the devices with one or more servers and/or with each other. The communication can take place over media such as standard telephone lines, LAN or WAN links (e.g., T1, T3, 56 kb, X.25), broadband connections (ISDN, Frame Relay, ATM), wireless links (802.11 (Wi-Fi), Bluetooth, GSM, CDMA, etc.), for example. Other communication media are possible. The network can carry TCP/IP protocol communications, and HTTP/HTTPS requests made by a web browser, and the connection between the clients and servers can be communicated over such TCP/IP networks. Other communication protocols are possible.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

In some cases, relational or other structured databases can provide such functionality, for example, as a database management system which stores data for processing. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The terms and expressions employed herein are used as terms and expressions of description and not of limitation, and there is no intention, in the use of such terms and expressions, of excluding any equivalents of the features shown and described or portions thereof. In addition, having described certain implementations of the invention, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A computer storage medium comprising instructions that, when executed by a processor, cause the processor to perform acts comprising:
receiving an ad request from a client computing device, wherein the ad request includes at least one of an identifier of a user of the client computing device or an identifier of the client computing device;
based upon at least one of the identifier of the user or the identifier of the client computing device, identifying a tracking pool to which the identifier of the user or the identifier of the client computing device is assigned, the tracking pool comprising aggregated data indicative of behavior or characteristics of the user of the client computing device and at least one other user, wherein the aggregated data fails to include an identity of the user or the client computing device;
providing the aggregated data to an advertising server, wherein responsive to receipt of the aggregated data, the advertising server determines whether to serve an ad in response to the ad request, wherein the advertising server fails to receive the identifier of the user or the identifier of the client computing device in connection with determining whether to serve the ad; and
responsive to receiving an indication that the advertising server has determined that the ad is to be served in response to the ad request, causing the ad to be displayed within electronic content displayed at the client computing device.

2. The compute storage medium of claim 1, further comprising:
receiving tracking data pertaining to at least one of the identifier of the user or the identifier of the client computing device;
assigning, to the tracking pool, the at least one of the identifier of the user or the identifier of the client computing device to which the tracking data pertains; and
updating the aggregated data to include the received tracking data.

3. The computer storage medium of claim 2, wherein the assigning is based upon a behavior or characteristic being indicated in the tracking data and the behavior or characteristic being indicated in the aggregated data.

4. The computer storage medium of claim 2, wherein the assigning is based upon a number of identifiers assigned to the tracking pool being less than a maximum tracking threshold.

5. The computer storage medium of claim 2, wherein the tracking data comprises at least one of demographic information, geographic information, social networking information, web browser history, advertisement view history, advertisement click history, or conversion history pertaining to the user.

6. The computer storage medium of claim 1, wherein the advertising server determines whether to serve the ad in response to the ad request based upon a targeting threshold pertaining to a first characteristic or a first behavior, wherein the aggregated data indicates a fraction users assigned to the tracking pool that has the first characteristic or exhibits the first behavior.

7. The computer storage medium of claim 1, wherein providing the aggregated data to the advertising server is based upon the tracking pool having at least a minimum threshold number of identifiers assigned thereto.

8. The computer storage medium of claim 1, wherein the aggregated data includes a web browsing history of the user.

9. The computer storage medium of claim 1, wherein the aggregated data indicates a number of times the user has visited a website.

10. A computing system comprising:
a processor; and
memory that stores instructions that, when executed by the processor, cause the computing system to perform acts comprising:
receiving user data that includes:
an identifier that is indicative of a user; and
tracking data that is indicative of at least one of a characteristic of the user or a behavior of the user;
assigning the user to a tracking pool that has a plurality of users assigned thereto, the tracking pool comprising aggregated data that is indicative of characteristics and/or behaviors of the plurality of users, wherein the aggregated data fails to include identifiers of the plurality of users;
updating the aggregated data to include the tracking data;
responsive to receiving an ad request that includes the identifier from a client computing device, providing the aggregated data to an advertising server, wherein responsive to receipt of the aggregated data, the advertising server determines whether to serve an ad in response to the ad request, wherein the advertising server fails to receive the identifier in connection with determining whether to serve the ad; and
responsive to receiving an indication that the advertising server has determined that the ad is to be served in response to the ad request, causing the ad to be displayed within electronic content displayed at the client computing device.

11. The computing system of claim 10, wherein the advertising server determines whether to serve the ad in response to the ad request based upon a targeting threshold pertaining to a first characteristic or a first behavior, wherein the aggregated data indicates a fraction of the plurality of users assigned to the tracking pool that has the first characteristic or exhibits the first behavior.

12. The computing system of claim 10, wherein the user is a first user, the tracking pool is a first tracking pool, the plurality of users is a first plurality of users, wherein a fraction of the first plurality of users having a first characteristic or exhibiting a first behavior exceeds 50%, the acts further comprising:
assigning the first user to a second tracking pool that has a second plurality of users assigned thereto based upon the first user having a second characteristic or exhibiting a second behavior, wherein a fraction of the second plurality of users having the second characteristic or exhibiting the second behavior exceeds 50%.

13. The computing system of claim 12, wherein the aggregated data is first aggregated data, and wherein the second tracking pool comprises second aggregated data, the acts further comprising:
providing second aggregated data to the advertising server responsive to receipt of the ad request, wherein the advertising server determines whether to serve the ad based upon the first aggregated data and the second aggregated data.

14. A method, comprising:
receiving user data that includes:
an identifier that is indicative of a user; and
tracking data that is indicative of at least one of a characteristic of the user or a behavior of the user;
assigning the user to a tracking pool that has a plurality of users assigned thereto, the tracking pool comprising aggregated data that is indicative of characteristics and/or behaviors of the plurality of users, wherein the aggregated data fails to include identifiers of the plurality of users;
updating the aggregated data to include the tracking data;
responsive to receiving an ad request that includes the identifier from a client computing device, providing the aggregated data to an advertising server, wherein responsive to receipt of the aggregated data, the advertising server determines whether to serve an ad in response to the ad request, wherein the advertising server fails to receive the identifier in connection with determining whether to serve the ad; and
responsive to receiving an indication that the advertising server has determined that the ad is to be served in response to the ad request, causing the ad to be displayed within electronic content displayed at the client computing device.

15. The method of claim 14, wherein the advertising server determines whether to serve the ad based upon a probability of the user in the plurality of users having a first characteristic, the probability being indicated by the aggregated data.

16. The method of claim 14, wherein the advertising server determines whether to serve the ad based upon a probability of the user in the plurality of users having taken an action, the probability being indicated by the aggregated data.

17. The method of claim 14, wherein the advertising server determines whether to serve the ad based upon a probability of the user in the plurality of users having seen the ad or another ad in a first period of time, the probability being indicated by the aggregated data.

18. The method of claim 14, wherein the advertising server determines whether to serve the ad based upon an advertising conversion rate weighted by a probability of the plurality of users having seen ads to which the advertising conversion rate pertains, the advertising conversion rate indicated by the aggregated data.

19. The method of claim 14, further comprising:
receiving a second ad request that includes an identifier that is indicative of a second user assigned to the tracking pool;
providing the aggregated data to the advertising server responsive to receiving the second ad request, wherein responsive to receipt of the second aggregated data, the advertising server determines whether to serve a second ad in response to the second ad request; and
responsive to receiving an indication that the advertising server has determined that the second ad is to be served in response to the ad request, causing the second ad to be displayed within second electronic content displayed at a second client computing device associated with the second user.

20. The method of claim 14, wherein the identifier is an identifier of the user or an identifier of a computing device associated with the user.
